(19) United States
(12) Patent Application Publication
(10) Pub. No.: US 2012/0001963 A1
(43) Pub. Date: Jan. 5, 2012

(54) MULTI PRIMARY CONVERSION

(75) Inventors: Karel Johannes Gerhardus Hinnen, Eindhoven (NL); Gerben Johan Hekstra, Waalre (NL); Erno Hermanus Antonius Langendijk, Eindhoven (NL); Remco Theodorus Johannes Muijs, Eindhoven (NL); Michiel Adriaasnzoon Klompenhouwer, Eindhoven (NL)

(73) Assignee: KONINKLIJKE PHILIPS ELECTRONICS N.V., EINDHOVEN (NL)

(21) Appl. No.: 13/255,255

(22) PCT Filed: Mar. 3, 2010
(86) PCT No.: PCT/IB2010/050919

§ 371 Date: Sep. 8, 2011

(30) Foreign Application Priority Data
Mar. 9, 2009 (EP) 09154645.7

(51) Int. Cl. G09G 5/10

(52) U.S. Cl. 345/690

(57) ABSTRACT

A multi-primary conversion (5) of input drive values (RGB) defines a color of a pixel (PI) of a multi-primary display(DP) in an M dimensional color space (XYZ) into N>M output drive values (di) in an N dimensional drive space. The N output drive values (di) drive N sub-pixels (SPi) of the pixel (PI). The color of the pixel (PI) in the color space (XYZ) is defined by linear combinations of N color primaries of the respective N sub-pixels (SPi). The multi-primary conversion(5) comprises: defining a constraint in the color space (XYZ) thereby causing in the color space (XYZ) a convex polytope (U0; L0; V50) defined by vertex points (V10, V11, V12; V20, V21; V50), wherein only colors in the color space (XYZ) belonging to the convex polytope fulfill the constraint, determining exemplary solutions of the output drive values (di) for at least a subset of the vertex points (V10, V11, V12; V20, V21; V50), and constructing the output drive values (di) fulfilling the constraint as a convex combination of the exemplary solutions.

### FIELD OF THE INVENTION

The invention relates to a multi-primary conversion, a computer program product to perform the multi-primary conversion, a multi-primary converter, and a multi-primary display apparatus comprising the multi-primary converter.

### BACKGROUND OF THE INVENTION

Conventional displays have pixels with 3 sub-pixels (also referred to as color pixels) per pixel. Usually, the pixel comprises a red, green and blue sub-pixel with color coordinates according the EBU norm. This selection of the colors of the sub-pixels allows an easy signal processing of the input signal which has or which can be converted into corresponding red, green and blue components for driving the respective colored sub-pixels. The color (luminance and chrominance) of a pixel is defined by the drive values of the sub-pixels. These drive values indicate a linear combination of the color primaries of the colors of the sub-pixels.

Multi-primary displays use N>3 color primaries to represent a color. Thus, the multi-primary display has N sub-pixels per display pixel. The N colors of the N sub-pixels are the color primaries which define an N dimensional drive space. Compared to conventional RGB-displays, multi-primary displays may be designed to have an increased gamut size and a better covering of the natural colors. Furthermore, the multi-primary displays may yield advantages in terms of peak brightness, cost, and power consumption. Especially because of the latter reason, multi-primary technology is important for mobile applications. However, the concept has also advantages for larger screen sizes, such as an improved gamut size, a higher peak brightness, and a lower power consumption, which may be important differentiators for the future television and computer monitor business. The only way to fully exploit the potential of such a multi-primary display is to have a possibility to efficiently convert the input content, typically coded in RGB, into an N-component drive signal for the N sub-pixels.

This conversion, known as multi-primary conversion (further also referred to as MPC) is a delicate and complicated process. This conversion has not only to eliminate the additional freedom provided by the extra primaries, but it also has to reach the mentioned advantages. This means that the freedom has to be limited in a smart way to optimize the behavior of the multi-primary display. However, especially for multi-primary displays with more than 4 color primaries, a very high amount of processing power is required to implement the desired constraints.

An important step in limiting the freedom of the 3 to N conversion is to solve the color matching problem by limiting the solutions to those which have the correct color.

Another step is to implement balanced or equal luminance constraints in sub-pixel distribution techniques for resolution enhancement. For example, in a 6 color primary display, the pixels of the display have 6 sub-pixels which may be divided in two sub-pixel groups of 3 sub-pixels. If is assumed that the dimensions of the sub-pixels of the multi-primary display are identical to the sub-pixels of a RGB display wherein each pixel has 3 sub-pixels, the resolution of the 6 color primary display is halved. To restore the resolution as much as possible, the luminance of adjacent sub-pixel groups is allocated to resemble as much as possible the luminance of the corresponding adjacent pixels of the RGB display. This process of having control over the luminance distribution between the sub-pixel groups is also referred to as sub-pixel rendering.

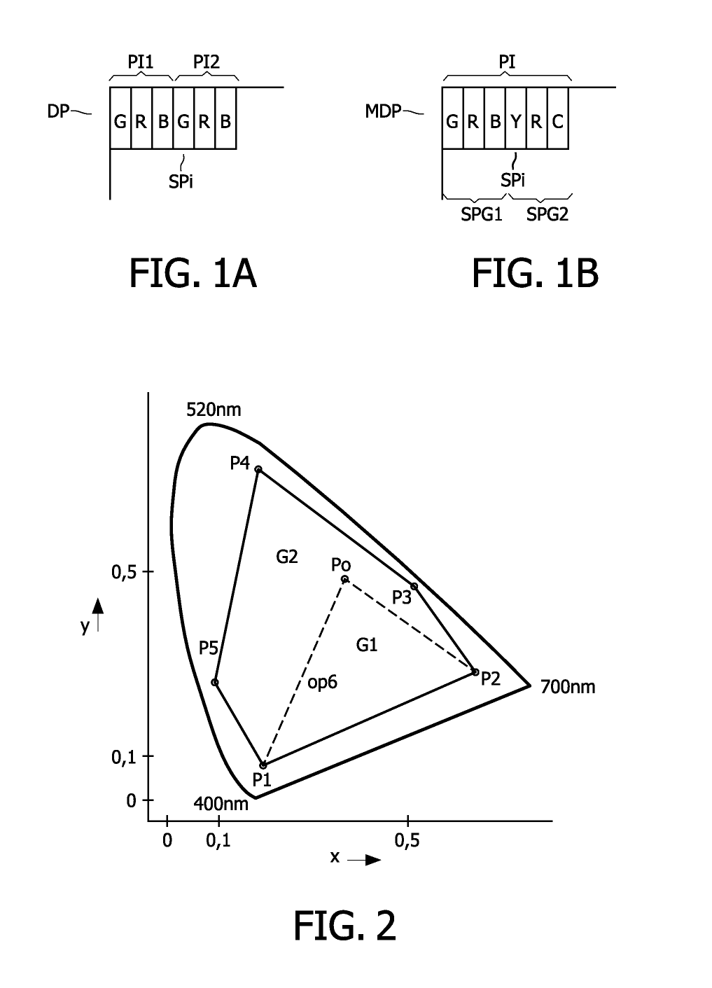

The sub-pixel rendering imposes additional constraints on the multi-primary conversion. To make this more explicit, consider the multi-primary sub-pixel layout in FIG. 1B. The first objective in multi-primary conversion is to match the colors of the input to the pixels PI of the multi-primary display MDP. For the considered sub-pixel layout, this corresponds to matching the color of the multi-primary display to the average color of two input pixels PI1 and PI2 of FIG. 1A. This matching results in a loss of resolution if no constraints are imposed on the luminance distribution over the groups of sub-pixels. The input steering the luminance distribution does not necessarily correspond to physical pixels but may also be obtained as the output of a balancing filter which redistributes the colors over the sub-pixel groups. From a perceptual point of view, resolution is mainly determined by the detail in luminance rather than in color. In sub-pixel rendering this is used to increase the apparent resolution by redistributing the luminance over the sub-pixel groups SPG1 and SPG2. The freedom in multi-primary conversion enables to realize the desired luminance distribution between the sub-pixel groups SPG1 and SPG2.

In the example of FIG. 1, the sub-pixels of the multi-primary display are divided into two sub-pixel groups; a group SPG1 composed of a green, red and blue sub-pixel and a group SPG2 composed of a yellow, red and cyan pixel. Luminance balancing now refers to the ability of the multi-primary conversion algorithm to influence the distribution of the luminance between both sub-pixel groups, without (or with a minimal) influence on the total pixel color XYZ. This process may be performed by imposing a constraint specifying the desired luminance in the first sub-pixel group. Such a constraint could for instance be used to match the luminance of sub-pixel group SPG1 with the luminance of the pixel PI1, and the luminance of the sub-pixel group SPG2 with the luminance of the pixel PI2.

Similar to the balanced luminance constraint, it is possible to define a constraint on the desired distribution of color over the sub-pixel groups. Since the balanced luminance constraint already operates on the luminance distribution over the groups, this component may be excluded for the balanced chrominance constraint. Balanced chrominance is referred to as the ability to impose a certain distribution between X1Z1 and X2Z2 (in the XYZ color space) of the first and the second sub-pixels SPG1 and SPG2. Balanced luminance and chrominance are data dependent constraints which are hard to incorporate in a look-up table (further also referred to as LUT) based multi-primary conversion.

The use of balanced luminance constraints in multi-primary conversion to find a defined solution for the drive values of the sub-pixels of the multi-primary display is known for systems with 4 primaries. However, the efficient specific approaches for 4 color primary multi-primary displays are not applicable to multi-primary displays with more than 4 color primaries. On the other hand, a brute force approach to impose balanced luminance constraints will be very computationally intensive for more than 4 color primaries. The constraint on distribution of color over the sub-pixel groups can be used to eliminate the freedom is systems with more than 4 primaries.

### SUMMARY OF THE INVENTION

It is an object of the invention to provide a multi-primary conversion which is also efficient for multi-primary displays having more than 4 color primaries.

A first aspect of the invention provides a multi-primary conversion as claimed in claim 1. A second aspect of the invention provides a computer program product as claimed in claim 13. A third aspect of the invention provides a multi-primary converter as claimed in claim 14. A fourth aspect of the invention provides a multi-primary display apparatus as claimed in claim 15. Advantageous embodiments are defined in the dependent claims.

A multi-primary conversion in accordance with the first aspect of the invention converts input drive values defining a color of a pixel of a multi-primary display in an M dimensional color space into N>M output drive values in an N dimensional drive space. Usually, the M dimensional color space is a linear 3 dimensional color space such as the CIE XYZ or the linearized CIELAB space. Usually, the input drive values define sets of three values indicating the input color as a linear combination of the color primaries RGB. As these input drive values are meant to drive a three primary RGB display, one such set of three values defines the color (intensity and hue) of one pixel of the conventional 3 sub-pixel per pixel display. The N output drive values drive the N sub-pixels of the pixel of the multi-primary display. The color of the pixel of the multi-primary display is defined in the color space by linear combinations of the output drive values of the N color primaries of the respective N sub-pixels. It has to be noted that the N color primaries can be represented in the 3 dimensional linear color space, while the N output drive values, when independent, are defined in an N dimensional linear output space.

Considering the driver constraints, each color point in the color space can be related to a set of possible drive values. The set of possible drive values forms a polytope of which the vertex points can be computed by a computational inefficient trial and error approach, referred to as matrix switching. The present invention is directed to implementing the constraint with respect to the multi-primary conversion in the color space and to decrease the number of vertex points that has to be computed. The implementation of the constraint in the 3 dimensional color space is much easier and requires less effort than directly implementing the constraint in the N>3 dimensional drive space. The amount of matrix operations is decreased by only converting a limited number (or even only a single one) of vertex points of polytopes in the color space which fulfill the constraint.

Thus, the multi-primary conversion defines a constraint in the color space which results in a convex polytope defined by vertex points in the color space such that only the colors belonging to the convex polytope in the color space fulfill the constraint. Next, the exemplary solutions in the drive space of the output drive values for at least a subset of the vertex points in the color space are determined. Finally the output drive values fulfilling the constraint are obtained as a convex combination in the drive space of the exemplary solutions in the drive space. A convex combination is a linear combination of points (which may be vectors or scalars) using coefficients which are positive and sum up to 1. All possible convex combinations of points are within or on the borders of the convex hull defined by the points.

Each color point in the color space defines a convex polytope (a parallelotope) in the drive space defined by vertex points. The vertex points in the drive space may be computed by “Matrix switching”. Matrix switching is able to find the vertex points in the drive space which define the convex polytope in the drive space covering the solutions in the drive space for the color point in the color space. These solutions in the drive space are the convex combinations of the vertex points in the drive space. The vertex points in the drive space are related to the vertex points of a polytope in the color space by linear mapping, and the other way around. These vertex points in the drive space are referred to as the exemplary solutions for the color point in the color space. A more efficient way to determine the exemplary solutions will be discussed with respect to an embodiment of the present invention. However, it has to be noted that this efficient manner is not limited to the present invention and can be implemented in every multi-primary conversion to find the exemplary solutions in the N dimensional drive space of a particular color in the 3 dimensional color space.

The present invention is directed to only find the exemplary solutions of the, or a subset of the, vertex points of the polytope in the color space which fulfill the constraint. As will become clear with respect to the embodiments, the constraint may be directed to the color, luminance, or the chrominance of a pixel or a sub-pixel group of the multi-primary display.

In an embodiment, the N sub-pixels of the multi-primary display are divided over groups of sub-pixels. The N sub-pixels of all the groups together are referred to as a pixel of the multi-primary display. The constraint is determined in the color space as a convex polytope of colors of a first one of the groups still allowing obtaining a desired color of the pixel with valid output drive values of the remaining groups. The exemplary solutions of the output drive values are determined by the exemplary solutions of the vertex points of the convex polytope. The valid output drive values are drive values which can be generated by the drive circuits. Usually the range of valid drive values is limited by the power supply voltage(s) used for the drive circuit. In the now following, the valid range of the output drive values is normalized to the range of 0 to 1 including the border values.

This embodiment of the invention is based on the insight that the convex polytope of solutions satisfying the color matching problem can easily be related to the freedom of color for the sub-pixel groups. There is a one to one relation between the vertex points of the polytope in color space describing the freedom in color of the first sub-pixel group such that desired output color can still be achieved, and the exemplary solutions in the drive space. This convex polytope describes all possible decompositions of the desired output color in colors that can be realized by the individual sub-pixel groups. Relating the exemplary solutions to the freedom in color is attractive as the balanced luminance and chrominance constraints are formulated in the same color space. For example, in the linear XYZ color space, the balanced luminance is targeted at imposing a desired value on the luminance of the first sub-pixel group, while the balanced chrominance constraint specifies a desired value for the remaining chrominance components. The process of imposing constraints hence reduces to operations on the vertex points characterizing the remaining amount of freedom.

For example, if the pixels of a 6 primary multi-primary display are composed of two groups of 3 sub-pixels, the constraint is that the color for the first group of 3 sub-pixels is selected such that the desired color can still be reached by valid drive values of the second group of 3 sub-pixels. The polytope covering all the colors fulfilling the constraint can be found in the color space by determining the intersection of a polytope defined by the primaries of the first group and a polytope defined by the primaries of the second group with an offset such that the desired color of the pixel is one of the vertex points (the one furthest away from the origin) of this last mentioned polytope.

In the example shown in FIG. 1, the sub-pixels of the multi-primary display are divided into two sub-pixel groups. Luminance balancing now refers to the ability of the multi-primary conversion algorithm to influence the distribution of the luminance between both sub-pixel groups, without or with a minimal influence on the total pixel color. This luminance balancing provides a constraint specifying the desired luminance in the first sub-pixel group. Such a constraint could for instance be used to match the luminance of first input pixel with the luminance of the first sub-pixel group, and the luminance of second input pixel with the luminance of the second sub-pixel group. Usually, the desired luminance for the sub-pixel groups is determined as a part of the sub-pixel rendering process.

In an embodiment, the constraint in addition to the color matching constraint further comprises a luminance constraint defining a desired luminance of one of the sub-pixel groups. In this embodiment, the exemplary solutions of the output drive values are determined for the vertex points of an intersection polytope in the color space defined as the intersection of the plane representing the desired luminance and the polytope defining the colors of the one of the sub-pixel groups fulfilling the luminance constraint. In the now following the one of the sub-pixel groups is referred to as the first sub-pixel group, which, however, does not indicate that this group must be the first (from left to right) in position.

By characterizing the freedom in color of the first sub-pixel group, the balanced luminance constraint can be conveniently applied. Applying the constraint basically boils down to computing the intersection of the convex polytope in color space which fulfills the color matching constraint and a plane of desired luminance for the first sub-pixel group. This can be achieved by dividing all vertex points into two groups, one group with luminances larger than the desired luminance and one group with luminances smaller than the desired luminance. By considering the line segments that connect points in these groups and also form an edge of the considered color matching convex polytope, the intersection points can be computed as the linear combination that yields the correct luminance. The computed intersection points form the vertex points of the set of all solutions that satisfy both the color matching and balanced luminance constraint. If the desired luminance is smaller or larger than the minimum or maximum luminance solution, the balanced luminance constraint cannot be satisfied in an equality sense. A least squares solution is obtained by clipping the desired luminance to the nearest value of the color matching convex polytope.

It has to be noted that the present invention is not limited to implementing the constraint in the manner discussed for each one of the constraints. For, example, the determination of the desired color of the first sub-pixel group may be obtained by determining the exemplary solutions for the desired color of the total pixel and to transform the drive values of the primaries of the first sub-pixel group back to the color space to obtain the color matching convex polytope in the color space. In this embodiment, next, the luminance constraint is implemented on the so found color matching convex polytope.

In an embodiment, the constraint further comprises implementing a chrominance constraint on the intersection polytope. Similar to the balanced luminance constraint, one can define a constraint on the desired distribution of color over the sub-pixel groups. Since the balanced luminance constraint already operates on the luminance distribution over the groups, this component may be excluded for the balanced chrominance constraint. Given the vertex point(s) of the convex intersection polytope in the color space, the balanced chrominance constraint is straightforward to apply. If the desired color for the first sub-pixel is within the intersection polygon it is also the optimal color for this group. Otherwise, the optimal color is the point within the color matching polytope which minimizes the mean square distance to the desired color.

After applying the balanced luminance constraint, the set of feasible solutions is either a point or a convex polygon. In the latter case there is still a multitude of solutions to select from. As discussed, this selection can be made by imposing a balanced chrominance constraint. This results in a procedure of successively adding constraints, narrowing down the solution set, until a unique solution is left. Such a procedure is based on the assumption that one can make a clear ordering of the importance of the applied constraints. However, compared to an approach based on weighing the relative importance of constraints in a cost-function, this leads to a more efficient implementation as it avoids the need for numerical optimization.

In an embodiment, a luminance constraint defining a desired luminance of the first one of the groups has been added to the color matching constraint. This desired luminance constraint is implemented in the color space by determining the vertex points which have the minimum luminance respectively the maximum luminance of the color matching polytope which defines the desired color, and by determining the coefficients of a convex combination of these vertex points. The coefficients define an intersection of the line through these vertex points and a plane representing the desired luminance. The exemplary solutions of the output drive values in the drive space for the intersection in the color space are determined as the convex combination of the output drive values for the vertex points having minimum luminance respectively maximum luminance using the coefficients determined in the color space.

This approach further improves the computational efficiency by only considering the exemplary solutions that have the minimal and maximal amount of luminance concentrated in the first sub-pixel group. This simplification avoids the need to impose the balanced chrominance constraint in order to arrive at a unique well defined solution. By considering only the minimum and maximum luminance solutions, the entire procedure reduces to taking convex combinations thereof. The objective is to find the convex combination that approaches the desired luminance for the first sub-pixel group as closely as possible. This leads to an efficient multi-primary conversion algorithm that is able to account for balanced luminance constraints.

In an embodiment the constraint comprises a luminance constraint defining a desired luminance of the first one of the groups. The exemplary solutions of the output drive values in the drive space are determined in the color space as an intersection of a plane representing the desired luminance and a line defined by the extreme luminance vertex points of the polytope defining the desired color which have minimum, respectively maximum luminance. The exemplary solutions of the output drive values are determined for the vertex point of the intersection.

In an embodiment, the exemplary solutions of the output drive values of the vertex points are obtained by using the known matrix switching approach wherein all color primaries in the color space are divided in sets of a group of N-3 color primaries having selected values and a group of 3 color primaries having free values. The color primaries of the group with selected values have either the value zero or one. The group of color primaries has free values in the sense that the free values can be selected or determined to obtain the desired color in the polytope defined by the primaries with fixed values. Or said differently, the primaries with fixed values determine the offset for the polytope defined by the free primaries. If the value for all free primaries is selected to be 0, this results in the color point defined by the primaries with the fixed values. Thus, the polytope of colors which can be obtained starts from this color point defined by the values of the fixed primaries and covers all color points which can be realized with a convex combination of the valid values of the free primaries. In this manner, by selecting all possible combinations of the primaries to have fixed values 0 or 1, the total gamut can be covered with multiple polytopes which usually partly overlap.

Thus, the sets of fixed and free primaries provide a set of (overlapping) polytopes completely covering the color gamut defined by the N color primaries, the matrix switching approach checks for each one of the set of polytopes whether the input color defined by the input drive values is within the polytope and if yes performs a matrix operation to determine the drive values from the selected values (0 or 1) of the fixed primaries on the one hand and the input color together with the color primaries having the free values on the other hand.

In an embodiment the determining of the exemplary solutions of the vertex points is performed by determining or retrieving pre-determined boundary planes of the gamut polytopes. The gamut polytopes in the color space are defined by N-3 fixed primaries of the N color primaries of which the value is selected either 0 or 1, together with the 3 variable primaries of the N color primaries. Thus, the gamut polytopes have volumes defined by the 3 variable color primaries, and the volumes have an offset with respect to the origin defined by the selected values of the fixed color primaries. The values of the fixed color primaries are selected to be either 0 or 1. If these gamut polytopes are defined for all possible combinations of the values 0 or 1 for all possible combinations of the N-3 fixed primaries, the resulting volumes cover the complete gamut of colors which can be generated with the color primaries. It has to be noted that the resulting volumes will partly overlap. The gamut polytopes may be selected such that the gamut is completely covered without overlap between the polytopes. Using non-overlapping polytopes provides a more efficient process of determining the exemplary solutions because a lower number of boundary planes of the gamut polytopes have to determined or retrieved. The position of the desired output color is determined with respect to the boundary planes to indicate the gamut polytopes wherein the desired output color lies.

In an embodiment, the position is determined by determining the normals of the boundary planes, and by calculating the inner product of the normals and the vector defining the desired output color. The sign of the inner product indicates at which side of the boundary plane the desired output color is situated. In this manner, it is possible to conclude on whether the desired output color lies within or outside a particular one of the gamut polytopes by only checking the signs.

In an embodiment, the boundary planes are grouped into groups of parallel boundary planes. The normals are calculated only once for each one of the groups. To decide on the position of the desired output color with respect to the parallel planes it suffices that the parallel planes are ordered with respect to their distance to the origin.

In an embodiment, the position of the desired output color is determined by calculating a distance of the desired color with respect to the boundary planes. This distance may be used both to determine in which gamut polytope the desired output color lies and to determine the values of the variable primaries required to obtain the desired output color.

These and other aspects of the invention are apparent from and will be elucidated with reference to the embodiments described hereinafter.

In the drawings:

FIG. 1 schematically shows a pixel arrangement of a conventional RGB display and a multi-primary display with 6 color primaries,

FIG. 2 schematically shows the xy color space with an example of a selection of the 6 color primaries,

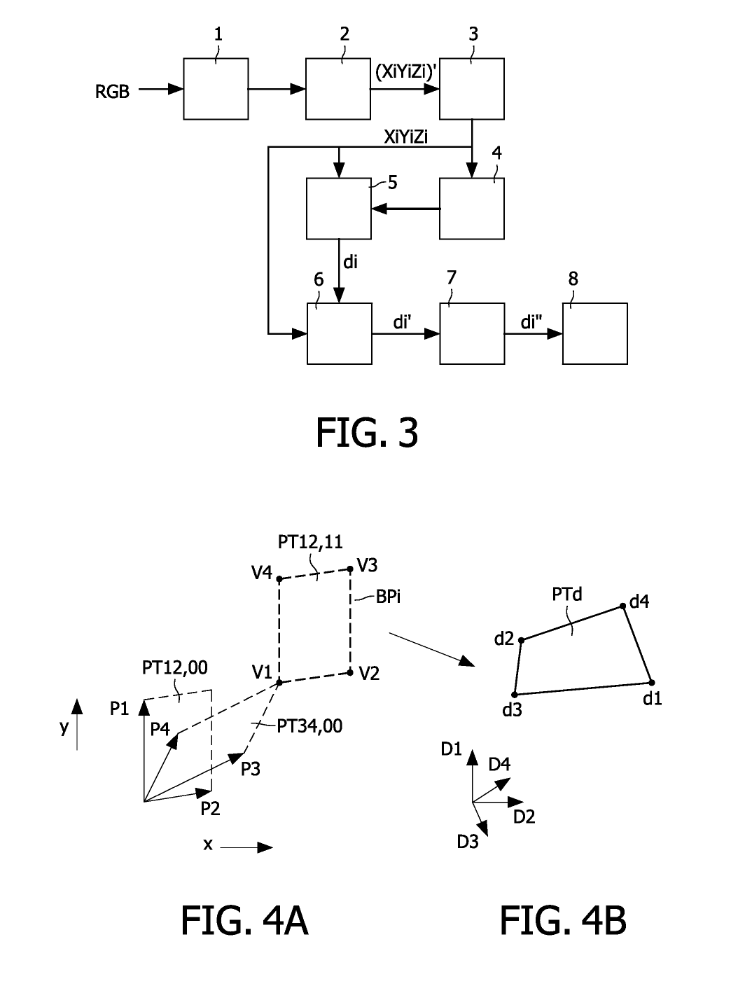

FIG. 3 shows a block diagram of a display apparatus with a multi-primary converter,

FIG. 4 shows gamut polytopes in the 2-dimensional color space XY and in a 4 dimensional drive space,

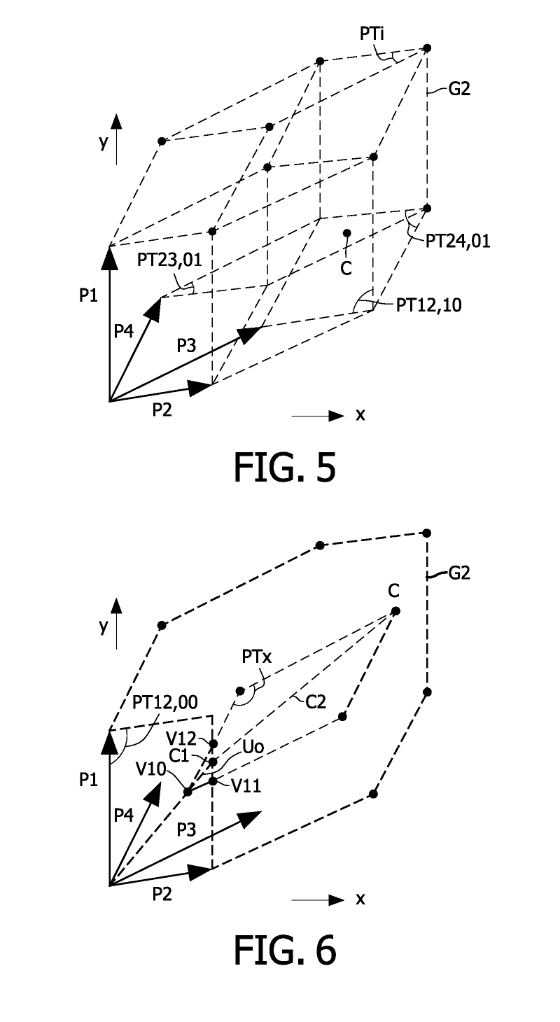

FIG. 5 shows all gamut polytopes of a 4 primary multi-primary display in the 2-dimensional color space XY,

FIG. 6 illustrates how the desired gamut polytope comprising the colors of the first sub-pixel group of the multi-primary display which still allow to reach the desired color of the pixel of the multi-primary display by the second sub-pixel group of the pixel,

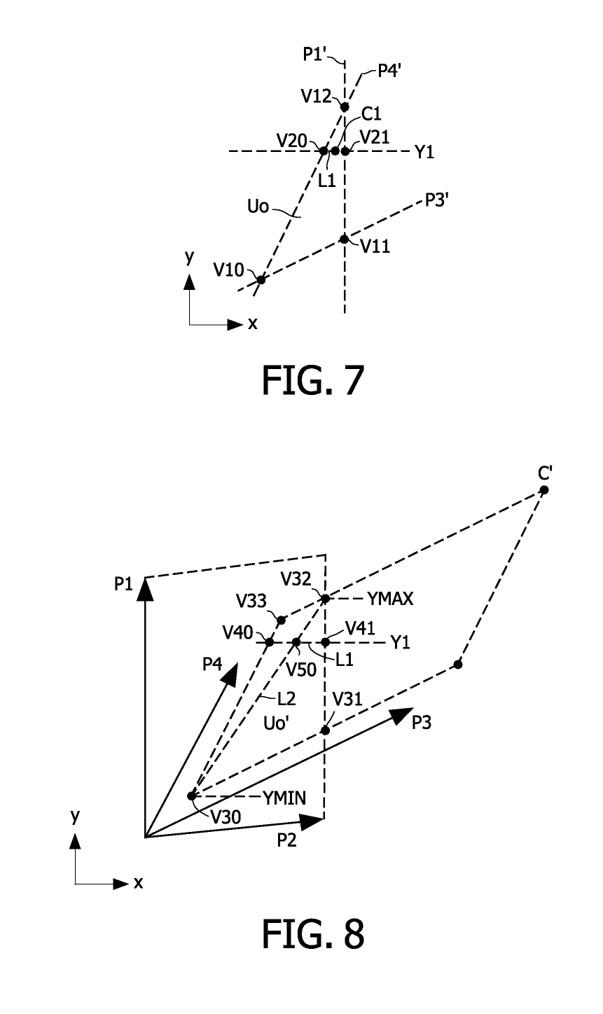

FIG. 7 illustrates how the intersection polytope of the desired gamut polytope of the first sub-pixel group and the plane representing the desired luminance of the first sub-pixel group,

FIG. 8 illustrates how to find the polytope or color point of the first sub-pixel group having the desired color and the desired luminance by using the extreme luminance vertex points of the desired gamut polytope,

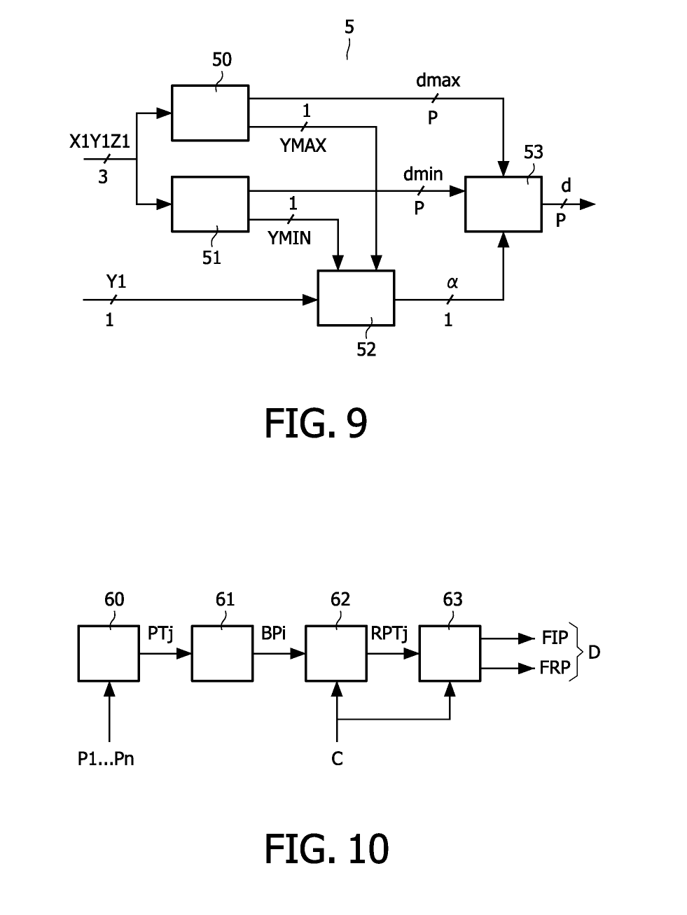

FIG. 9 shows a block diagram of an embodiment of a multi-primary converter in accordance with the invention,

FIG. 10 schematically shows a block diagram for determining the exemplary solutions of a desired output color,

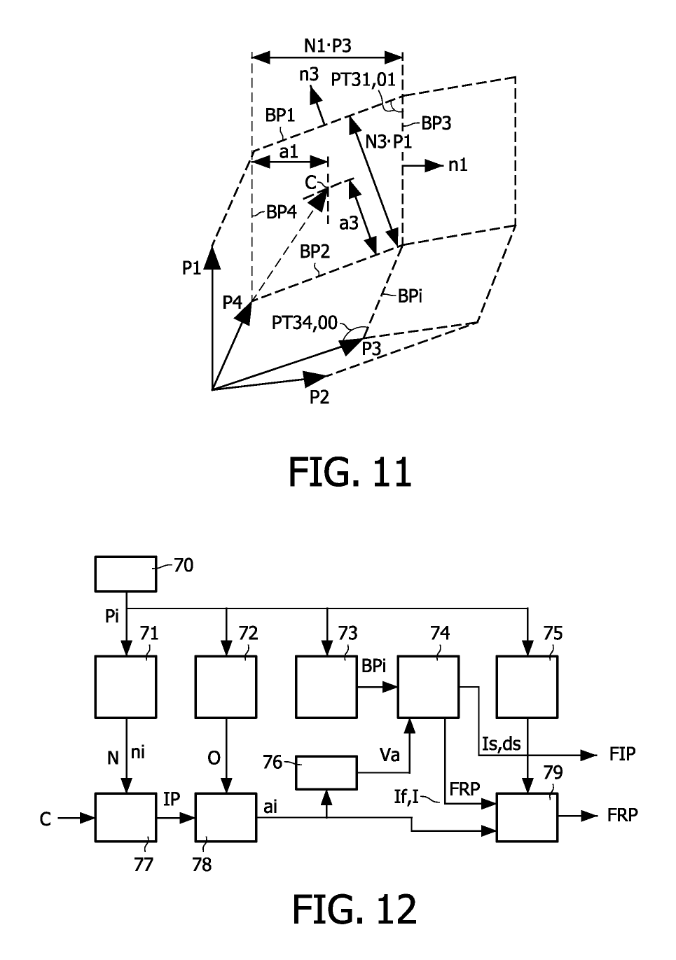

FIG. 11 shows a set of non-overlapping gamut polytopes, and

FIG. 12 shows a block diagram of an efficient embodiment for determining the exemplary solutions of a desired output color.

It should be noted that items which have the same reference numbers in different Figures, have the same structural features and the same functions, or are the same signals. Where the function and/or structure of such an item has been explained, there is no necessity for repeated explanation thereof in the detailed description.

### BRIEF DESCRIPTION OF THE EMBODIMENTS

FIG. 1 schematically shows a pixel arrangement of a conventional RGB display and a multi-primary display with 6 color primaries. An actual display may have much more pixels than shown.

The RGB display DP has pixels PI1, PI2 each with three sub-pixels SPi which have the colors R (red), G (green), B (blue). The input signal which has to be displayed on the display DP has RGB or other components, such as for example YUV, which can easily be converted into RGB components. These RGB components define the drive values for the respective RGB sub-pixels. Because the number of sub-pixels per pixel is identical to the number of components of the input signal, the drive values can be deterministically found from the RGB components.

The multi-primary display MDP has pixels PI with 6 sub-pixels SPi which for example have the colors GRBYRC, wherein G is green, R is red, B is blue, Y is yellow, and C is cyan. In this example, the first group of sub-pixels SPG1 comprises the colors GRB, the second group of sub-pixels SPG2 comprises the colors YRC. This multi-primary display has 6 color primaries corresponding to the colors of the 6 sub-pixels. The color primaries may all have but must not all have different colors.

If the area of each one of the sub-pixels of the RGB display DP and the multi-primary display MDP are identical, the pixels PI cover twice the area of each one of the pixels PI1, PI2. Consequently, the resolution of the display MDP is half the resolution of the display DP. Because the resolution is predominantly determined by the luminance, the resolution of the display MDP can be restored by determining an optimal luminance distribution over the sub-pixel groups SPG1 and SPG2. This luminance distribution is supplied to the multi-primary conversion as the balanced luminance constraint. An optimal luminance distribution may be that the luminance ratio of the sub-pixel groups SPG1 and SPG2 is identical to the luminance ratio of the pixels PI1 and PI2. Alternatively, any other sub-pixel rendering algorithm may be implemented.

Although the multi-primary display MDP shown has 6 sub-pixels per pixel, the number of sub-pixels per pixel may have any other number>3, and the colors of the sub-pixels may be different than shown in FIG. 1. The sub-pixels of the multi-primary display may be divided in more than two groups. The groups of sub-pixels of the multi-primary display may have a different number of sub-pixels.

FIG. 2 schematically shows the xy color space with an example of a selection of the 6 color primaries. The triangle defined by the EBU color primaries P0, P1, P2 is the gamut of colors G1 which can be realized with a conventional RGB display of which the sub-pixels SPi have the EBU RGB colors as the primaries. The color primaries P1, P2, P3, P4, P5, P6 indicate the polytope G2 defining the color gamut of the multi-primary display MDP.

FIG. 3 shows a block diagram of a display apparatus with a multi-primary converter. The display apparatus comprises an optional inverse gamma processing 1, an RGB to XYZ converter 2, a color processing 3, a sub-pixel balancing 4, a multi-primary convertor 5, a sub-pixel distribution 6, an optional gamma correction 7, and a multi-primary display 8.

The inverse gamma processing 1 compensates for any gamma pre-correction of the RGB input signal. The inverse gamma processing 1 together with the RGB to XYZ converter 2 converts the RGB input signal into a linear input signal (XiYiZi)′ in the linear XYZ space according to CIE. The optional color processing 3 may perform any desired processing such as for example luminance peaking, hue correction or gamut expansion and supplies the color XiYiZi. The sub-pixel balancing 4 provides a balancing constraint to the multi-primary convertor 5. For example, such a balancing constraint may be the luminance balancing of the two or more groups of sub-pixels of the multi-primary display 8. The sub-pixel balancing 4 may provide further processing. For example, an anti-aliasing operation may be performed on the output signal XiYiZi of the color processing 3 before this output signal is supplied to the multi-primary converter 5. In the embodiment shown in FIG. 3, the output signal of the sub-pixel balancing 4 is directly supplied to the multi-primary converter 5. The multi-primary convertor 5 converts its input signal XiYiZi in the XYZ space into drive values di in the N dimensional drive space for the N color primaries (or N sub-pixels) of the multi-primary display 8. The sub-pixel distribution 6 distributes the drive values di over the N sub-pixels to obtain distributed drive values di′. The optional gamma processing 7 applies a gamma operation on the distributed drive values di′ to obtain gamma corrected drive signals di″ suitable for particular type of the display 8 used.

The processes of the blocks shown may be performed with dedicated hardware, a suitable programmed processor, or a combination thereof.

FIG. 4 shows gamut polytopes for a 2-dimensional color space XY and a 4 dimensional drive space (i.e. 4 color primaries). In the now following the embodiments of the invention will be explained by way of example in a hypothetical 2D (2-dimensional) color space XY instead of the 3D color space XYZ. This “flatland” analogy has advantages in that it allows for a convenient 2D-graphical representation without the need of using perspective or difficult projections in the 3D space. All presented ideas however generalize to, and should be applied in, the 3D-colour space. When necessary, the relation between the 2D-representation and 3D-space will be discussed.

FIG. 4A shows in the XY space only three polytopes PT12,00, PT34,00 and PT 34,11 to illustrate how the complete set of polytopes of FIG. 5 is obtained. This example considers 4 color primaries P1 to P4 defined by the colors of the 4 sub-pixels SPi of the pixel PI of the multi-primary display 8. The explanation presented can easily be applied to a higher number of color primaries defined by the sub-pixels of the multi-primary display 8.

In the example shown, the colors of the 4 sub-pixels SPi are defined by the color primaries P1, P2, P3 and P4. The notation used for the polytopes is PTij,kl, wherein i and j indicate the free primaries and k and l indicate whether the fixed primaries are selected to be zero or one. The values of k and l indicate the fixed primaries in the order of their subscript. Thus, the polytope PT12,00 is defined by the free primaries P1 and P2 and the fixed primaries P3 and P4, both with value 0, respectively. The polytope PT34,00 is defined by the free primaries P3 and P4 and the fixed primaries P1 and P2 both with value 0. The polytope PT12,11 with vertex points V1, V2, V3, V4 is defined by the free primaries P1 and P2 and the fixed primaries P3 and P4 both with value 1. The vertex point V1 is obtained if both P1 and P2 are 0. The vertex point V4 is obtained if P1 has the value 1 and P2 has the value 0. Thus, the polytope PT12,11 covers all colors which can be realized when P3 and P4 have the value 1 and the values of P1 and P2 are varied in their valid range 0 to 1, including the border values 0 and 1.

FIG. 4B very schematically shows a polytope PTd in the N (=4) dimensional drive space defined by the primaries being the axis D1, D2, D3, D4 of the sub-pixels SPi of the multi-primary display 8. Because both the XYZ color space and the drive space are linear spaces, a one to one relation exists between the color vertex points Vi (V1 to V4 are explicitly indicated) and the drive values di (d1 to d4 which are schematically represented in the 4 dimensional drive space). The drive values d1, d2, d3, d4 which are the extreme drive values of the primaries D1 to D4, respectively are for point V1 equal to [0 0 1 1], respectively. These extreme drive values d1 to d4 are also referred to as the exemplary solutions, which will be further elucidated with respect to FIG. 5. It has to be noted that in the now following the polytopes PTij,kl in the color gamut are also referred to as the gamut polytopes PTi wherein i may indicate a particular one of the gamut polytopes or all the gamut polytopes in general. In the same manner the primaries P1 to P4 may be referred to as Pi, and the exemplary solutions d1 to d4 may be referred to as di.

FIG. 5 shows all gamut polytopes of a 4 primary multi-primary display in the 2-dimensional color space XY. The total area covered by the partly overlapping gamut polytopes PTi is the gamut G2 of the colors which can be realized with the 4 primaries Pi. The gamut polytopes PTi are found in the same manner as explained with respect to FIG. 4A by taking all combinations of two of the primaries Pi as the fixed primaries and all combinations of the remaining primaries as the free primaries. In the 3D color space XYZ, N-3 primaries have to be fixed to the value 0 or 1 and for each combination of values of the fixed primaries the remaining 3 primaries are free such that the colors of the gamut polytope PTi are defined by the 3 free primaries starting from an offset vector defined by the values of the fixed primaries. In the now following is explained how the exemplary solutions di for the color C are determined. The color C lies within 3 gamut polytopes PTi.

The first gamut polytope PT 12,10 is defined by the free primaries P1 and P2 and the fixed primaries P3=1 and P4=0. Thus, the offset vector is P3. The exemplary solution di corresponding to the gamut polytope PT 12,10, is given by the appropriate values of the drive values d1 and d2 in accordance with the appropriate values of P1 and P2, and the values of the drive values d3 and d4 are 1 and 0, respectively,

The second gamut polytope PT23,01 is defined by the free primaries P2 and P3 and the fixed primaries P1=0 and P4=1. Thus, the offset vector is P4, and the exemplary solution di corresponding to the gamut polytope PT23,01 is given the appropriate values of the drive values d2 and d3 in accordance with the appropriate values of P2 and P3, and the values of the drive values d1 and d4 are 0 and 1, respectively.

The third gamut polytope PT24,01 is defined by the free primaries P2 and P4 and the fixed primaries P1=0 and P3=1. Thus, the offset vector is P3, and the exemplary solution di corresponding to the gamut polytope PT24,01 is given by the appropriate values of the drive values d2 and d4 in accordance with the appropriate values of P2 and P4, and the values of the drive values d1 and d3 are 0 and 1, respectively,.

The exemplary solutions di are extreme solutions because the values of the fixed primaries have been selected to have one of the extreme values 0 or 1. Consequently, the three exemplary solutions di defined above are the vertex points of the gamut polytope PTd in the N-dimensional drive space comprising all convex combinations of drive values for which the color C is obtained. The vertex points in the drive space are directly related to the vertex points in the color space by the linear relation between the drive values and the color. In this example: Vi=P1*d1+P2*d2+P3*d3+P4*d4.

The matrix switching approach has to test all possible combinations of fixed primaries to find the gamut polytopes in which the color C is present. In fact, the matrix switching approach has to perform a vector decomposition (matrix multiplication assuming precompiled inverses) for the free primaries of each one of the gamut polytopes PTi to calculate the drive values di in the drive space. Only the gamut polytope(s) PTi in which the color C is positioned will lead to drive values within their valid range.

FIG. 6 illustrates how the desired gamut polytope which comprises the colors of the first sub-pixel group SPG1 of the multi-primary display MDP which still allow reaching the desired color C of the pixel PI of the multi-primary display 8 by the second sub-pixel group SPG2 of the pixel PI.

It is assumed that the color primaries Pi of the sub-pixels SPi of the first group SPG1 are P1 and P2 and that the color primaries Pi of the sub-pixels SPi of the second group SPG2 are P3 and P4. The question to be solved is: which colors in the gamut polytope PTi defined by the primaries P1 and P2 provide a color of the first group SPG1 such that the color of the second group SPG2 in combination with the color of the first group SPG1 is able to generate the desired color C using drive values di in the valid range. FIG. 6 shows that the polytope U0 with the vertex points V10, V11, V12 is a sub-area of the gamut polytope PT12,00 defined in that the color C1 of the first group SPG1 must be selected to be able to reach the desired color C with adding a color C2 defined by the primaries P3 and P4 to the color C1. As is shown in FIG. 6 this polytope U0 is defined by the colors common to the polytope PT12,00 and the polytope PTx which is the polytope defined by the free primaries P3 and P4 of which the color C is the one of the vertex points of this polytope having the largest distance to the origin. The construction of the polytope U0 in the example shown in FIG. 6 is better visible in FIG. 7 which shows an enlarged version of the polytope U0 and its neighborhood.

Alternatively, the determination of the desired color of the first sub-pixel group may be obtained by determining the exemplary solutions for the desired color of the total pixel and to transform the drive values of the primaries of the first sub-pixel group back to the color space to obtain the color matching convex polytope in the color space. In this embodiment, next, the luminance constraint is implemented on the so found color matching convex polytope.

The above is described more in general in the now following. The colors C1 and C2 are vectors in the XYZ space:

C1=[X1 Y1 Z1]^{T} and C2=[X2 Y2 Z2]^{T} wherein T means transposed.

Assuming that both groups of sub-pixels SPG1 and SPG2 cover the same area, the total color C of the pixel PI is defined as:

C=½(C1+C2) (1)

For other distributions of the areas of the groups of sub-pixels SPG1 and SPG2, the contributions of the groups have to be scaled accordingly and the arithmetic mean is replaced by a weighted average to account for the contribution of the respective groups in area.

It is assumed that for a desired color C we know the exemplary solutions D={d1, . . . , dn}of the color matching problem. The color matching problem is defined as the problem of finding the drive values for the first and the second group SPG1 and SPG2 that satisfy

x=Ps1 ds1+Ps2 ds2 with 0≦ds1, ds2≦1 (2)

wherein the columns of the matrices Ps1 and Ps2 are composed of the display primaries of the first group SPG1 and the second group SPG2, respectively, scaled according to their contribution area. The drive values for the sub-pixels of the first group SPG1 are defined by the vector ds1 and the drive values for the sub-pixels of the second are defined by the vector ds2.

Since a multi-primary system has more primaries than the dimension of the color space, the color matching problem typically has multiple solutions for colors within the gamut. As can be verified, the set of solutions satisfying equation (2) forms a convex polytope, which can be characterized as the convex combination of the points D={d1, . . . , dn}, which are referred to as the exemplary solutions. Thus, set of all drive values dj that yield the desired output color C can be expressed as all dj belonging to the drive space for which:

dj=Σᵢ αᵢdᵢ wherein Σᵢ αᵢ=1 and αᵢ≧0.

The exemplary solutions D may be computed by means of matrix switching. A faster way of determining the exemplary solutions will be discussed with respect to FIG. 10. Alternatively, the ds1 component of the exemplary solution may be used to determine the vertex points of the polytope U0.

After determining the exemplary solutions D to characterize the freedom in color C1 of the first group SPG1, a next constraint to the multi-primary conversion may be the balanced luminance constraint, and possible a balanced chrominance constraint. For any solution of dj for a color within the polytope U0, the total intensity contribution by both sub-pixel groups SPG1 and SPG2 is fixed as dj satisfies the color matching condition in equation (1). The balanced luminance constraint is targeted at controlling the distribution of the luminance between both sub-pixel groups SPG1 and SPG2. Approaches to implement the balanced luminance constraint are discussed with respect to FIGS. 7 to 9.

FIG. 7 illustrates how the intersection of the polytope U0 describing the freedom in color of the first sub-pixel group SPG1 and the plane Y1 representing the desired luminance of the first sub-pixel group SPG1 is determined.

FIG. 7 shows an enlarged version of the polytope U0 defined in FIG. 6. The lines parallel with the primaries P1, P3 and P4 which are the border lines of the polytope U0 are indicated by P1′, P3′ and P4′, respectively. The polytope U0 has the vertex points V10, V11 and V12. The luminance constraint to be applied on the first group SPG1 is that the luminance of this group should be Y1. In the 2D color space XY this luminance constraint is defined by the line Y1. In the 3D color space XYZ the luminance constraint is a plane indicating the luminance value Y1. From FIG. 7 it is immediately clear that the line portion L1 between the vertex points V20 and V21 defines the colors which fulfill both the color matching and the luminance constraint. Or said more general: the colors which fulfill both the color and the luminance constraint are defined by the vertex points of the polytope which is the intersection between the polytope U0 which indicates the colors fulfilling the color constraint and the plane indicating the desired luminance Y1.

After determining the set of colors defined by the polytope U0, the problem of imposing the balanced luminance constraint is basically to find the colors that are closest to the desired luminance Y1. Now two situations can occur. First, if the desired luminance Y1 is either smaller or larger than the luminance of all individual vertex points of the polytope U0, it is impossible to achieve equality. In this case the optimal color for the first group of sub-pixels SPG1 corresponds to the vertex point with the minimum or maximum luminance, respectively. The optimal drive value dj is now the exemplary solution that corresponds to the selected vertex point. On the other hand, if desired luminance Y1 is between the minimal and maximum luminance of the vertex points of the polytope U0, the balanced luminance constraint can be imposed in an equality sense. The set of all colors of the sub-pixel group SPG1 which satisfy this constraint is obtained by taking the intersection L1 of U0 and the set of colors with the desired luminance Y1.

One way of computing the required intersection L1 is to determine the vertex points V20 and V21 of this intersection. These vertex points V20, V21 may be computed by dividing the vertex points V10, V11 and V12 into two groups, one group with luminance larger than the desired luminance Y1 and one group with luminance smaller than the desired luminance Y1. In the example of FIG. 7, V10 and V11 belong to the first group, while V12 belongs to the second group. The next step is to find all possible line segments between the points in these groups that are also an edge of the polytope U0. In the example shown, these line segments are the lines P1′ and P4′. The intersection of these lines with the plane Y1 (or line Y1 for the 2D-simplification shown) provides the vertex points V20 and V21 of the polygon L1. The vertex points of the intersections are hence convex combinations of the vertex points of the polytope U0. The drive values of these new vertex points can be updated by taking the corresponding convex combinations in the drive domain. This approach also is valid if the distance of the color C′ with respect to the origin is smaller such that the polytope U0 has 4 vertex points as is shown in FIG. 8.

After the set L1 has been determined, a balanced chrominance constraint can be applied in a similar manner. If the desired color C1 for the first sub-pixel group SPG1 is an element of L1, this color is the optimal color of the group. In this case, it is possible to reach the desired output color C while fulfilling the constraints for both the balanced luminance and chrominance. On the other hand, if the polytope L1 does not comprise the desired color C1 for the first group SPG1, the color C1 for the first sub-pixel group SPG1 can be computed by minimizing the mean square distance between a point and a polygon in a 2D-plane. This problem can be easily solved by geometrical methods. Given the optimal color C1, equation (1) can be used to determine the color C2. From this subdivision in colors, the optimal drive values dj can be conveniently computed. As an alternative, the drive values dj can be computed by the taking convex combination in drive space that corresponds to the convex combination of vertex points of L1 needed to achieve the optimal color C1.

The proposed procedure of successively applying a balanced luminance and balanced chrominance constraint is still rather computational intensive. If the computational complexity is too high and is considered to be a bottleneck, the balanced chrominance condition may be disregarded to arrive at a simplified low-cost solution. However, to ensure a certain amount of robustness it is important to reduce the remaining amount of freedom in a well-defined and unique manner. To arrive at a more efficient way of incorporating the balanced luminance constraint, the exemplary solutions with minimum and maximum luminance may be used as will be explained with respect to FIG. 8

FIG. 8 illustrates how to find the polytope or color point of the first sub-pixel group SPGi having the desired color C1 and the desired luminance Y1 by using the extreme luminance vertex points of the gamut polytope U0′.

In FIG. 8, the gamut polytope U0′, which comprises the colors of the first sub-pixel group SPG1 which allow to reach the color C′ with the second sub pixel group SPG2, has 4 vertex points V30 to V33. The line L1 defines the colors which have the desired luminance Y1 within the gamut polytope U0′. The line L2 is constructed as the line through the vertex points V30 and V32 with respectively the minimum luminance and the maximum luminance of the gamut polytope U0′. The intersection V50 of this line L2 with the line L1 provides the selected color C1. In the 3D color space XYZ, the line L1 is a plane and the line L2 may be a polytope if the vertex points with minimum and maximum luminance are not unique

Alternatively, it is possible to define the balanced luminance constraint by taking the convex combination:

d=α dmax+(1−α) dmin wherein 0≦α≦1, dmax and dmin are the exemplary solutions for the vertex points V30 and V32 with minimum and maximum luminance, respectively, of the gamut polytope U0′. The value of a is defined by the convex combination of the vertex points V30 and V32 such that the intersection V50 is obtained between the Y1 luminance plane and the polytope through the vertex points V30 and V32. The value of a is determined in the color space by:

α=(Y1−Ymax)/(Ymax−Ymin)

wherein Ymax is the luminance of the color of the vertex point V32, and Ymin is the luminance of the color of the vertex point V30.

If the computed a is outside the range [0, 1] it is simply clipped to the nearest extreme value. This approach leads to a very efficient way of imposing a balanced luminance constraint. Moreover, by taking convex combinations of the minimum and maximum solutions it is still possible to generate solutions in the same luminance range for the sub-pixel group SPG1 as the extended approach discussed before. This implies that the luminance constraint can be satisfied to the same extent as before. Furthermore, it should be noted that the proposed procedure allows for an additional improvement in computational complexity as it only requires the exemplary solutions with minimal and maximal luminance. An efficient way for computing dmin and dmax will be explained with respect to FIG. 10.

FIG. 9 shows a block diagram of an embodiment of a multi-primary converter in accordance with the invention. The multi-primary converter 5 comprises the blocks 50 and 51 which receive the desired color X1Y1Z1 to determine the maximum and minimum luminance Ymax and Ymin of the extreme vertex points V32 and V30, respectively, of the polytope U0′ (see FIG. 8) and the exemplary solutions dmax and dmin of the corresponding drive values. As described with respect to FIG. 8, the block 52 computes the factor a from the desired luminance Y1 and the maximum and minimum luminance Ymax and Ymin. Block 53 mixes the maximum and minimum drive values dmax and dmin with the factor a to obtain the exemplary solution as d=α dmax+(1−α) dmin.

The above algorithms provide a way to impose balanced luminance and chrominance constraints on the set of exemplary solutions achieving a color match in multi-primary conversion. Together with an approach for computing the exemplary solutions dj, it provides a multi-primary conversion scheme that is able to deal with this type of data dependent constraints. In contrast to known approaches of incorporating balanced luminance constraints, the algorithm is not restricted to systems with four primaries. The ability to impose balanced luminance constraints in multi-primary conversion is essential for sub pixel rendering techniques. Sub-pixel rendering is an important tool in multi-primary systems with a larger amount of primaries in maintaining a high resolution without the need to increase the pixel count. As such, the proposed algorithm can be an essential ingredient in unleashing the full potential of future multi-primary panels, providing a wide gamut and high peak brightness on the one hand while maintaining a high resolution on the other hand. To arrive at a computationally more efficient version of the algorithm it has been suggested to consider only the exemplary solutions dj with minimum and maximum luminance in the first sub-pixel group SPG1. In this case, the whole procedure of incorporating the balanced luminance constraint reduces to finding the convex combination that yields the desired luminance Y1. Combined with the techniques for the fast computation of exemplary solutions as presented with respect to FIG. 10, this leads to a very efficient multi-primary conversion algorithm.

FIG. 10 schematically shows a block diagram for determining the exemplary solutions D of a desired output color C. The blocks of the block diagram are realized with dedicated hardware, with a suitably programmed processor, or a combination thereof.

The optional block 60 defines or retrieves the gamut polytopes PTj from the color primaries P1 to PN of the sub-pixels SPi of the pixel PI of the multi-primary display 8. The block 61 may determine the boundary planes BPi of the gamut polytopes PTj, but preferable retrieves stored pre-calculated data defining the boundary planes BPi. For example, the boundary planes BPi may be defined by their normals ni (see FIG. 11) and offset. Alternatively, it is possible to define parallel extending boundary planes BPi by a single normal ni and their relative position.

The block 62 determines the position of the desired output color C with respect to the boundary planes BPi to provide the gamut polytope or polytopes PTj in which the output color C lies. For example, the inner product of the vector representing the desired output color C and the normal ni of the boundary planes BPi may be calculated. This inner product together with the order of the parallel arranged boundary planes BPi directly indicates in which gamut polytope(s) PTj the desired output color C may be positioned and in which not. By considering all sets of parallel bounding planes the gamut polytopes PTj that contain C can be unique identified. When is known in which gamut polytope(s) PTj the desired output color C is positioned, for each one of these gamut polytopes PTj, the value of the fixed primaries FIP is known.

The block 63 determines the values of the free primaries FRP in each one of the gamut polytopes PTj of which is detected that the desired output color C is positioned in. Now, for each one of these gamut polytopes PTj to which the desired output color C belongs, the values of both the fixed primaries FIP and free primaries FRP is known and thus also the exemplary solutions D are known.

In the now following this approach is discussed in more detail. The drive values di for the sub-pixels SPi of the pixels PI of the multi-primary display 8 which cause the correct desired output color C of the pixel PI form a polytope in the drive space. This polytope is defined by its vertex points called exemplary or extreme solutions D of the drive values d1 to dN. Such a polytope in the drive space is further referred to as a drive polytope.

Matrix switching provides one way to compute the exemplary solutions D. An embodiment of the invention is directed to a more efficient algorithm than the matrix switching approach to calculate the exemplary solutions D. This algorithm in accordance with the present invention is based on determining the position of the desired output color C with respect to the boundary planes DPi limiting the gamut polytopes PTj in the color gamut G2. The gamut polytopes PTj in the color space XYZ are defined by the color primaries P1 to PN of the sub-pixels SPi. The gamut G2 of colors in the color space XYZ comprises all colors which can be generated by valid drive values di of the sub-pixels SPi of a pixel PI. The valid values of the drive values di are normalized to the range 0 to 1 including the border values. The gamut polytopes PTj are defined by selecting the fixed value of 0 or 1 for N-3 color primaries Pi while the values of the remaining 3 color primaries Pi may vary within their valid range of 0 to 1. The color primaries Pi which have a selected value of 0 or 1 are referred to as the fixed primaries FIP, the color primaries which may vary are referred to as the free primaries FRP. The set of gamut polytopes PTj may be created for all possible combinations of the fixed primaries FIP for all possible combinations of allocating the fixed values of 0 or 1 to the combinations of fixed primaries FIP. This complete set of gamut polytopes PTj covers the complete gamut and comprises partly overlapping polytopes PTj. An example of these overlapping polytopes PTj is shown in FIG. 5. It has to be noted that these gamut polytopes PTj can be pre-calculated from the coordinates of the primaries Pi of the sub-pixels SPi of the pixel PI. The position of the desired output color C with respect to the boundary planes BPi of the gamut polytopes PTj can be determined, for example, by calculating the inner product between the vector representing the desired output color C and the normal of the boundary planes Bpi and subtracting an appropriate offset 0. It has to be noted that also the boundary planes Bpi, the normals of the boundary planes BPi and the offsets 0 can be pre-calculated from the gamut polytopes PTj because the primaries Pi are defined by the actual multi-primary display 8. Instead of the representation of the boundary planes Bpi in terms of normals and offsets, any other representation of the boundary planes can be used to determine the relative position.

In an embodiment, the computational complexity is further reduced by selecting the gamut polytopes PTj such that they cover the complete gamut in a non-overlapping manner. The selection of the non-overlapping polytopes PTj may be based on a brute force approach, in which first all possible (candidate) polytopes are determined. In a next step, for each of the vertex points of each one of the polytopes PTj all exemplary solutions are determined. If, for example, we are interested in the unique covering of the gamut that corresponds to the solutions that have minimal luminance in the first sub-pixel group, it is determined which of the exemplary solutions for the vertex point satisfies this criterion. This is done for all vertex points of the candidate polytope. If the exemplary solutions that are selected all correspond to the same gamut polytope; i.e. the polytope that is tested it belongs to the covering without overlap. When this is not the case it is disregarded.

By determining the position of the desired output color C with respect to the boundary planes BPi of the gamut polytopes PTj it is possible to directly find the gamut polytopes PTj wherein the color C falls.

In an embodiment, the distance of the desired output color C to the boundary planes BPi of the gamut polytopes PTj is used to compute the required drive values di defined by the free primaries FRP. No brute force matrix switching is required wherein all candidate solutions must be computed to check which one leads to drive values di within the valid range of 0 to 1. The gain in computational efficiency of the algorithm in accordance with the embodiment of the present invention in comparison to matrix switching is shown in the following table.

| | | Computational effort | | |
|---|---|---|---|---|
| # | # | | Brute force | # |
| primaries | planes | Proposed algorithm | matrix switching | polytopes |
| 4 | 24 | 18M + 24A + 18Cs | 24M + 28A + | 8 |
| | | | 48Cf | |
| 5 | 80 | 30M + 80A + 70Cs | 90M + 120A + | 40 |
| | | | 240Cf | |
| 6 | 240 | 45M + 240A + | 180M + 480A + | 160 |
| | | 225Cs | 960Cf | |
| 7 | 672 | 64M + 672A + | 315M + 1680A + | 560 |
| | | 651Cs | 3360Cf | |
| 8 | 1792 | 84M + 1790A + | 504M + 5376A + | 1792 |
| | | 1764Cs | 10752Cf | |

The first column of the table indicates the number N of color primaries Pi of the multi-primary display MDP. The last column shows the number of all possible gamut polytopes PTj in the gamut. The second column shows the number of boundary planes BPi of the gamut polytopes PTi. The third column indicates the number of operations required to determine the relevant gamut polytopes in accordance with the algorithm of the invention, and the fourth column shows the number of operations required to determine the relevant gamut polytopes in the matrix switching approach. M is the number of multiplications, A is the number of additions, Cs is the number of sign comparisons, and Cf is the number of floating point comparisons. The algorithm in accordance with the present invention uses the boundary planes BPi and not the gamut polytopes PTj, while the matrix switching approach uses the gamut polytopes PTj and not the boundary planes BPi. Even though the number of boundary planes BPi that has to be considered is larger than the number of gamut polytopes PTj, the proposed algorithm leads to a significant reduction in computational complexity because the complexity of computing the projection of a point (the desired output color C) on a boundary plane BPi is a factor three lower than computing the drive values di for one of the gamut polytopes PTj (which are also known as matrix switching polytopes). The computation of the drive values di for one of the matrix switching polytopes PTj involves a vector with a three by three matrix multiplication.

Moreover, many of the boundary planes BPi extend in parallel, which enables to determine the relative position of the point representing the desired output color C with respect to the parallel boundary planes BPi in a single go. The projection of the point C on the parallel planes BPi is the same apart from a known offset between the planes BPi. Furthermore, the number of gamut polytopes PTj grows faster than the number of boundary planes BPi. This implies that the computational efficiency of the algorithm in accordance with the invention with respect to matrix switching increases with the number N of color primaries Pi involved.

The numbers in the table represent the worst case scenario. They represent the complexity required to determine the complete set of exemplary solutions D from the complete set of gamut polytopes PTj for the matrix switching approach, or the complete set of boundary planes BPi for the approach in accordance with the present invention. As already pointed out, a further reduction of the complexity can be achieved if not all exemplary solutions D are required. For example, if only the solutions D with the minimal or maximal luminance in a sub-pixel group SPGi are of interest, it is possible to pre-compute the corresponding covering of the gamut with gamut polytopes PTj which do not overlap but which together cover the complete gamut. Such a set comprising the minimum number of non-overlapping gamut polytopes PTj covering the complete gamut is referred to as the minimal luminance or maximal luminance set of gamut polytopes PTj, respectively. It has to be noted that this approach is not restricted to the algorithm proposed but also to the matrix switching approach.

FIG. 11 shows a set of non-overlapping gamut polytopes. The shown minimal luminance set for minimal luminance of the primaries P1 and P2 of the corresponding sub-pixels SPi is constructed by starting with the gamut polytope PT34,00 for which P1=P2=0 and P3 and P4 vary between 0 and 1. The other gamut polytopes PTj are selected such that they have one border line BPi in common and the gamut is completely covered by non-overlapping gamut polytopes PTj. Alternatively to the shown minimal luminance set, another minimal luminance set for which another combination of primaries is minimal can be selected. Instead of selecting a minimal luminance of a group of primaries, a maximum luminance may be selected.

The desired output color C lies in the gamut polytope PT13,01 of which the free primaries are P1 and P3, and the fixed primaries P2 and P4 have the values 0 and 1, respectively. The gamut polytope PT13,01 has boundary lines BP1 and BP2 with the normal n3 and boundary lines BP3 and BP4 with the normal n1. The distance between the boundary lines BP1 and BP2 is determined by the inner product of the vectors n3 and P1. The distance between the boundary lines BP3 and BP4 is determined by the inner product of the vectors n1 and P3. The distance of the desired output color C to the boundary line BP4 is a1, and the distance of the desired output color C to the boundary line BP2 is a3.

To determine which exemplary solutions are feasible, it is sufficient to look on which side of the boundary lines BPi (or boundary planes in the 3D color space XYZ) the desired output color C is located. The most straightforward way to determine on which side the desired output color C is located is to determine the distance to the plane. The distance is computed by taking the inner product with the normal ni of the boundary lines Bpi and subtracting the appropriate offset. The sign of the computed distance provides the information on which side of the boundary line BPi the desired output color C is located. Thus, if it is assumed that the directions of the normals ni for each of the boundary lines are pre-defined, it is possible to find the one gamut polytope PTj in which the desired output color C is located by only checking the signs of the inner products. For example, the directions of the normals ni may be selected to always point from left to right and from top to bottom (away for the origin). Once the one gamut polytope PTj has been found in which the desired output color C is located, the values of the fixed primaries FIP are known. In the example shown, the values of the fixed primaries P2 and P4 of the gamut polytope PT13,01 are 0 and 1, respectively.

The value of the inner product minus the offset provides the distance ai of the desired output color C to the boundary line BPi. These distances ai define the values of the free primaries FRP of the gamut polytope PTj in which the desired output color C is positioned. In the example shown, for polytope PT13,01 the value of the free primaries are given by P1=a3/(n3.p1) and P3=a1/(n1.p3). It has to be noted that the distances n3.p1 and n1.p3 only depend on the color points of the primaries P1 to P4 and thus can be pre-calculated. This approach directly uses the distances to the boundary lines PTj to perform the decomposition along the free primaries FRP and no vector-matrix multiplication is required.

The in this manner determined values of the fixed primaries FIP and the free primaries FRP directly provide or are the corresponding drive values d1 to d4 for the sub-pixels SPi of the pixel PI.

FIG. 12 shows a block diagram of an efficient embodiment for determining the exemplary solutions D of a desired output color C. The explanation of the operation of the implementation shown in FIG. 12 is given with respect to the linear 3D color space XYZ. However, any other linear 3D color space may be used. The central step of the algorithm is to compare the position of the desired output color C with the set of boundary planes BPi.

The block 70 provides the coordinates of the primaries Pi used to fill the look up tables 71, 72, 73 and 75. The block 71 is a look up table (further referred to as LUT) which defines the normal matrix N which comprises the normal vectors ni of the boundary planes BPi of the gamut polytopes PTi.

The block 77 receives the desired output color C and the normal matrix N to determine the inner products IP between the desired output color vector C and the normal vectors ni. Referring back to FIG. 11, the boundary planes BPi can be divided in groups of parallel planes. One such group comprises all boundary planes BPi with the same normal vector ni, but with different offsets defined by the inner product of the normal ni and the support vectors svi (not shown). The support vector svi of a particular boundary plane BPi may be any vector from the origin to the boundary plane BPi. Thus, for all planes BPi in one such group, the inner product IP between the normal vector ni of this group and the vector of the desired output color C has to be computed only once. For example the inner product IP for such a group may be calculated for a plane intersecting the origin and extending parallel to the planes of the group. The distance of the desired output color vector C with the actual planes BPi in the group is found by adding an appropriate offset indicating the displacement with respect to the parallel plane thought to intersect the origin.

The block 72 is a LUT which defines the offset matrix 0 which comprises the offsets of the corresponding parallel extending boundary planes BPi. The block 78 adds or subtracts the different offsets defined in the offset matrix 0 for the different parallel arranged planes BPi to obtain the correct distances ai of the desired output color C to each one of the parallel arranged planes BPi. The matrix 0 only depends on the coordinates of the primaries Pi and the selected gamut polytopes PTj and thus can be pre-calculated. Each row of the offset matrix 0 may contain the offsets of the corresponding normal in the normal matrix N. The offsets in each row may be sorted in descending order. The number of columns of the offset matrix 0 equals the maximum number of parallel planes BPi occurring in the groups of parallel planes BPi. Because not all groups of parallel planes BPi have this maximum number of parallel planes BPi, not all rows must be completely filled. In the 3D color space, the maximum number of columns is 2^{N-2} if all gamut polytopes PTi are considered and the number is 3 out of N when only considering the minimal luminance or maximal luminance set of gamut polytopes PTj.

The block 76 determines from the distances ai between which parallel boundary planes BPi the desired output color C is located. Hence, in determining the distance ai to all boundary planes BPi in one group of parallel planes BPi, the inner product between the normal vector ni of this group and the vector of the desired output color C has to be computed once for one of the parallel planes BPi, or for a plane through the origin which extends parallel to the planes BPi of the group. Given this inner product the distances from the desired output color C to the parallel planes is computed by subtracting the appropriate offset. As mentioned earlier, the sign of the distances ai indicates on which side of a boundary plane BPi the desired output color C is located. If the offsets in the matrix C are arranged in descending order, the process of determining between which boundary planes BPi the desired output color C is located can be performed by determining between which elements the rows of the offset matrix 0 change sign.

Thus, the relative position of the desired color C with respect to the parallel planes of the group can be expressed as a vector of integers Va which has a dimension equal to the number of groups of parallel boundary planes BPi. If in the 2D-example of FIG. 11 it is assumed that the numbering of the normals ni corresponds to the respective primaries P1 to P4, and that normals ni are signed such that they have a component pointing to the right (the normals ni of the parallel planes BPi are counted from left to right and from top to bottom), then the vector of integers Va for the desired output color C is Va=(2 1 1 1)^{T}. Or, defined in words: the desired output color C lies between the 2^{nd} and 3^{th} boundary plane BPi with the normal n1 perpendicular to the primary P1 and between the 1^{st} and 2^{nd} plane BPi of the planes of the group of boundary planes BPi which have the normals n2, n3 and n4 perpendicular to the primaries P2, P3 and P4, respectively. Thus, for determining the position of the desired color C it suffices that the block 76 knows the integer values of the vector Va, it is not required to know the exact distances di.

The integer location defined by the vector Va can be used to retrieve the gamut polytope(s) wherein the desired output color C is located. To this end the vector Va is compared element wise to a lookup table 74 which specifies upper and lower bounds that have to be satisfied for the desired output color C to belong to a particular gamut polytope PTi. In other words, the lookup table 74 specifies for each gamut polytope PTi between which integer values the elements of Va should be. In case of a minimal covering as shown in FIG. 11, precisely one gamut polytope PTi exists which satisfies all conditions. For a full covering of the gamut as shown in FIG. 5, multiple gamut polytopes PTi may pass the test, resulting in multiple exemplary solutions. The LUT 74 may be pre-constructed to comprise rows of the integer numbers wherein each row defines one of the gamut polytopes PTi, and wherein all the rows together define all the gamut polytopes PTi of the gamut. The numbering convention is identical to the numbering convention used for the vector Va. The polytope LUT 74 receives the information on the boundaries BPi of the gamut polytopes PTi from the pre-defined data in the polytope boundaries LUT 73.

Once the gamut polytope(s) PTi in which the output color C is positioned is known, the fixed primaries FIP and their extreme values are known. These fixed primaries FIP are the support vector of the gamut polytope PTi in which the output color C is positioned. The list of fixed primaries FIP is indicated by Is and the corresponding fixed values by ds . In the example of FIG. 11, only the gamut polytope PT13,01 supported by primaries P2=0 P4=1 and with the free primaries P1 and P3 pass the test. This implies that Is={2,4} and ds=[0,1]. Complementary, the polytope LUT 74 returns a list of the free primaries FRP, denoted by If and an identifier I of the boundary planes BPi emerging from the support vector of the gamut polytope PTi wherein the desired color C is positioned. The latter are specified in terms of a matrix I with indexes of the corresponding normals ni and offsets in ai and O. In the example of FIG. 11, If={1,3} and

$$I = [ \begin{matrix}1 & 2 \\ 3 & 2\end{matrix} ]$$

wherein the indexes in the first column refer to the boundary planes BPi with normal n1 and n3, respectively and the indexes in the second column indicate which of the parallel planes crosses through the end of the support vector P4. In the 2D color space discussed by way of example, the elements in If and the first column in I are identical. In the 3D color space, the elements in If generally differ from the ones in the first column in I.

In a last step, the values for the free parameters FRP are computed by the block 79. The contribution of the free primaries FRP is computed according to equations:

$$d 1 = \frac{a 3}{n 3 \cdot p 1} and d 3 = \frac{a 1}{n 1 \cdot p 3}$$

The required distances ai are retrieved from the entries in the distance matrix A specified by I. In the example shown in FIG. 11:

a1=A(1,2) and a=A(3,2).

The required normalization factors n1.p3 and n3.p1 are retrieved from the pre-computed normalization factors LUT 75. The matrix I can again be used for the appropriate indexing. Merging the computed values for the free primaries FRP and fixed primaries FIP finally provides the desired exemplary solution.

A main application of the invention is in the area of multi-primary conversion. The proposed bounding plane approach provides an efficient way to compute all exemplary solutions for a multi-primary display (for example, LCD, OLED, direct view or projection display) able to generate a certain desired output color C. A further reduction of computational complexity can be achieved by retrieving only a specific subset of exemplary solutions. Making such a pre-selection of solutions can be seen as selecting a specific set of non-overlapping gamut polytopes (which is also referred to as the minimal covering of the gamut). Having efficient ways to compute exemplary solutions is important in incorporating dynamic constraints, like the balanced luminance constraint, in multi-primary algorithms targeting more than four primaries. This type of flexibility is important for sub-pixel rendering techniques, which maintain a high resolution without the need for an increase in pixel count. As such, the proposed algorithm may be an important ingredient in unleashing the full potential of future multi-primary display panels which provide a wide gamut and high brightness on the one hand while maintaining a high resolution on the other hand.

It should be noted that the above-mentioned embodiments illustrate rather than limit the invention, and that those skilled in the art will be able to design many alternative embodiments without departing from the scope of the appended claims. The proposed approach has been developed for a system with 6 primaries, but applies also to systems with an arbitrary number>3 of color primaries. Although the approach has been partly elucidated with respect to a 2 dimensional color space XY for the sake of simplicity, it can be easily understood how the approach functions in the 3 dimensional color space XYZ, or in any other 3 dimensional linear color space.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A multi-primary conversion (5) of input drive values (RGB) defining a color of a pixel (PI) of a multi-primary display (DP) in an M dimensional color space (XYZ) into N>M output drive values (di) in an N dimensional drive space, wherein the N output drive values (di) drive N sub-pixels (SPi) of the pixel (PI), and wherein the color of the pixel (PI) in the color space (XYZ) is defined by linear combinations of N color primaries of the respective N sub-pixels (SPi), the multi-primary conversion (5) comprises:
defining a constraint in the color space (XYZ) thereby causing in the color space (XYZ) a convex polytope (U0; L0; V50) defined by vertex points (V10, V11, V12; V20, V21; V50), wherein only colors in the color space (XYZ) belonging to the convex polytope fulfill the constraint,
determining exemplary solutions of the output drive values (di) for at least a subset of the vertex points (V10, V11, V12; V20, V21; V50), and
constructing the output drive values (di) fulfilling the constraint as a convex combination of the exemplary solutions.

2. A multi-primary conversion as claimed in claim 1, wherein
the N sub-pixels (SPi) of the pixel (PI) are divided over groups (SPG1, SPG2) of sub-pixels (SPi),
the defining the constraint comprises determining in the color space (XYZ) a convex polytope (U0) of colors of a first one of the groups (SPG1) allowing to obtain a desired color (C) of the pixel (PI) with the remaining groups (SPG2),
the determining the exemplary solutions of the output drive values (di) is performed by determining the exemplary solutions as the output drive values (di) for the vertex points (V10, V11, V12) of the convex polytope (U0).

3. A multi-primary conversion as claimed in claim 1, wherein
the N sub-pixels (SPi) of the pixel (PI) are divided over groups (SPG1, SPG2) of sub-pixels (SPi),
the defining the constraint comprises a luminance constraint defining a desired luminance (Y1) of a first one of the groups (SPG1), wherein the desired luminance (Y1) is represented by a plane in the color space (XYZ),
the determining the exemplary solutions of the output drive values (di) determines the exemplary solutions as the output drive values (di) for the vertex points (V20, V21) of the polytope in the color space being defined as an intersection polytope (L1) obtained by the intersection of the plane representing the desired luminance (Y1) and a convex polytope (U0) of colors of the first one of the groups (SPG1) allowing to obtain a desired color (C) of the pixel (PI) with the remaining groups (SPG2).

4. A multi-primary conversion as claimed in claim 3, wherein the constraint further comprises implementing a chrominance constraint on intersection polytope (L1).

5. A multi-primary conversion as claimed in claim 1, wherein
the N sub-pixels (SPi) of the pixel (PI) are divided over groups (SPG1, SPG2) of sub-pixels (SPi),
the defining the constraint comprises a luminance constraint defining a desired luminance (Y1) of the first one of the groups (SPG1), wherein the constraint is implemented in the color space (XYZ) by determining:
the vertex points (V30, V32) as extreme luminance vertex points of a polytope (Uo) of colors of the first one of the groups (SPG1) allowing to obtain a desired color (C) of the pixel (PI) with the remaining groups (SPG2), which extreme luminance vertex points have minimum luminance (YMIN) respectively maximum luminance (YMAX), and coefficients (α, 1−α) of a convex combination of the extreme luminance vertex points (V30, V32), wherein the coefficients (α, 1−α) are mixing factors required for satisfying the luminance constraint and define an intersection of a line (L2) through the extreme luminance vertex points (V30, V32) and a plane representing the desired luminance (L1), and
the determining the exemplary solutions of the output drive values (di) is performed by determining the exemplary solutions corresponding with the intersection as a convex combination of the exemplary solutions of the output drive values (di) for the extreme luminance vertex points (V30, V32) using the coefficients (α, 1−α).

6. A multi-primary conversion as claimed in claim 1, wherein
the N sub-pixels (SPi) of the pixel (PI) are divided over groups (SPG1, SPG2) of sub-pixels (SPi),
the defining the constraint comprises a luminance constraint defining a desired luminance (Y1) of the first one of the groups (SPG1), wherein the constraint is implemented in the color space (XYZ) by determining:
an intersection (V50) of a plane representing the desired luminance (Y1) and a line (L2) defined by extreme luminance vertex points (V30, V32) of the polytope (U0) of colors of the first one of the groups (SPG1) allowing to obtain a desired color (C) of the pixel (PI) with the remaining groups (SPG2), which extreme luminance vertex points (V30, V32) have minimum luminance (YMIN) respectively maximum luminance (YMAX), and
the determining the exemplary solutions of the output drive values (di) is performed by determining the exemplary solution as the output drive value (di) for the vertex point of the intersection (V50).

7. A multi-primary conversion as claimed in claim 1, wherein the determining of the exemplary solutions of the output drive values (di) from the vertex points (V10, V11, V12; V20, V21; V50) is performed by using a matrix switching approach wherein all color primaries in the color space (XYZ) are divided in sets of a group of N-3 color primaries having selected values and a group of 3 color primaries having free values, wherein the color primaries of the group having selected values have the value zero or one, the sets provide all possible polytopes in a color gamut defined by the N color primaries, the matrix switching approach checks for each polytope whether the input color defined by the input drive values is within the polytope and if yes performs a matrix operation to determine the drive values from the selected values determining the polytope and the input color together with the color primaries having the free values.

8. A multi-primary conversion as claimed in claim 1, wherein the determining of the exemplary solutions of the vertex points is performed by:
determining or retrieving boundary planes of gamut polytopes (PTij,kl) in the color space (XYZ), wherein the gamut polytopes (PTij,kl) are defined by N-3 fixed primaries of the N color primaries of which the value is selected either 0 or 1, and 3 variable primaries of the N color primaries, and
determining a position of a desired output color (C) with respect to the boundary planes to indicate the gamut polytopes (PTij,kl) wherein the desired output color (C) lies.

9. A multi-primary conversion as claimed in claim 8, wherein the determining the position comprises determining:
normals of the boundary planes, and
an inner product of the normals, an offset value, and the vector defining the desired output color (C).

10. A multi-primary conversion as claimed in claim 9, wherein the determining of the normals comprises grouping the boundary planes in groups of parallel boundary planes, calculating the normals only once for each one of the groups, and indicating a distance of the parallel boundary planes in the same group with respect to the origin.

11. A multi-primary conversion as claimed in claim 9, wherein the determining of the position comprises calculating a distance of the desired color C with respect to the boundary planes for determining values of the variable primaries.

12. A multi-primary conversion as claimed in claim 8, wherein the determining or retrieving gamut polytopes (PTij,kl) comprises determining or retrieving a set of the gamut polytopes (PTij,kl) being non-overlapping while the set completely covers the color gamut defined by valid values of the color primaries.

13. A computer program product comprising computer code for performing a multi-primary conversion (5) of input drive values (RGB) defining a color of a pixel (P1) of a multi-primary display (DP) in an M dimensional color space (XYZ) into N>M output drive values (di) in an N dimensional drive space, wherein the N output drive values (di) drive N sub-pixels (SPi) of the pixel (P1), and wherein the color of the pixel (P1) in the color space (XYZ) is defined by linear combinations of N color primaries of the respective N sub-pixels (SPi), the code performs the steps of:
defining a constraint in the color space (XYZ) thereby causing in the color space (XYZ) a convex polytope (U0; LO; V50) defined by vertex points (V10, V11, V12; V20, V21; V50), wherein only colors in the color space (XYZ) belonging to the convex polytope fulfill the constraint, determining exemplary solutions of the output drive values (di) for at least a subset of the vertex points (V10, V11, V12; V20, V21; V50), and
constructing the output drive values (di) fulfilling the constraint as a convex combination of the exemplary solutions.

14. A multi-primary converter (5) for converting input drive values (RGB) defining a color of a pixel (PI) of a multi-primary display (DP) in an M dimensional color space (XYZ) into N>M output drive values (di) in an N dimensional drive space, wherein the N output drive values (di) drive N subpixels (SPi) of the pixel (PI), and wherein the color of the pixel (PI) in the color space is defined by linear combinations of N color primaries of the respective N subpixels (SPi), the multi-primary converter (5) comprises:
an input or memory for retrieving a constraint in the color space (XYZ) causing a convex polytope (U0; LO; V50) in the color space (XYZ) defined by vertex points (V10, V11, V12; V20, V21; V50), wherein only colors belonging to the convex polytope fulfill the constraint,
a calculating unit for determining exemplary solutions of the output drive values (di) for at least a subset of the vertex points (V10, V11, V12; V20, V21; V50), and for constructing the output drive values (di) fulfilling the constraint as a convex combination of the exemplary solutions.

15. A multi-primary display apparatus comprising:
a multi-primary display, and
the multi-primary converter of claim 9 arranged for supplying the output drive values to the sub-pixels of the multi-primary display.
